(19) United States
(12) Patent Application Publication
(10) Pub. No.: US 2018/0005326 A1
(43) Pub. Date: Jan. 4, 2018

(54) Electric Radiator Using Calculating Processors as a Heat Source

(71) Applicant: Ryan Allan Reid, Everett, WA (US)

(72) Inventor: Ryan Allan Reid, Everett, WA (US)

(21) Appl. No.: 15/626,874

(22) Filed: Jun. 19, 2017

Related U.S. Application Data
(60) Provisional application No. 62/356,713, filed on Jun. 30, 2016.

(51) Int. Cl. G06Q 50/06; G06Q 10/06; G06F 1/20

(52) U.S. Cl. CPC G06Q 50/06; G06F 1/206; G06Q 10/06315

(57) ABSTRACT

This invention includes a device which produces heat from calculating processors which may support a distributed trust protocol. The invention also includes business models which use the claimed device to provide heat, electronics, or processing power in various ways.

### FIELD

This disclosure relates to the field of electric heating. More specifically, it relates to electric heating generated by processors providing hash power to distributed trust protocols for data security and/or profit. This function is also known as verifying activity/transactions on a distributed trust protocol, such as a blockchain protocol. This process, when for profit, is commonly referred to as “cryptocurrency mining”.

### BACKGROUND

One method to heat buildings is known as electrical heating. Electrical heating generally uses electric radiators located in different rooms, each radiator heating that individual room. Each radiator is connected to an electric network to power one or more electric resistors used as a heat source.

In order to diffuse the heat in the room, there are several types of radiators. Heat produced by a heat source can be directly transmitted to ambient air, in the case of a convector, or through one of several bodies. Heat transfer between each body is made by a combination of conduction, convention, and radiation effects. In the case of convection, this can be natural or forced. Thus, the heat source can transmit heat or cooling produced to a fluid, the flow of which is natural or forced in the body of the radiator, the latter transferring heat, or lack thereof, to ambient air through its external surface.

Distributed computing is used for the growing requirements of many large-scale computer services. Typically this model consists of distributed processors or servers that are remotely accessed and given instruction, such as described in prior art. Distributed trust protocols, such as blockchain protocols, typically utilize nodes, networked together and cross checking each other, to store and secure data. The network of computers, or nodes, supporting distributed trust protocols typically do not have a master-slave relationship, particularly regarding public distributed trust protocols, as long as no one person or entity controls more than fifty percent of the total hash power, or processing power, on the network.

Cryptocurrency miners are primarily intended to preserve the integrity of certain distributed trust protocols. Integrity is typically preserved by multiple users in multiple locations using computers that are running the protocol and using processors to validate transactions or activity, via a consensus based distributed network, typically, in exchange for a reward.

Many cryptocurrency mining devices, once configured, do not require any physical interaction with final users. Therefore, they can be located in electric heating devices, such as space heaters, furnaces or other devices that utilize heat, so long as the device is configured to communicate via a wired or wireless network.

Cryptocurrency mining is mainly performed by one or more processors in a computer. There are generic processors called central processing units (CPU), and specialized processors such as graphics processing units (GPU). Efficiency in cryptocurrency mining can be increased by using application specific integrated circuits (ASIC) in networked devices. By executing specific instructions, the processor consumes electrical energy and discharges heat. Like the electric resistor, most of the energy consumed by the processor is discharged as heat. This amount of heat depends on technical characteristics of the processor and the rate at which it is intended to execute instructions. This heat is considered waste from a typical cryptocurrency miner and often leads to an additional cooling expense, both financially and environmentally.

### PRIOR ART REFERENCES

| | | Publication | | |
|---|---|---|---|---|
| Cited Patent | Filing date | date | Inventor | Title |
| U.S. Pat. No. 9,151,515 | Dec. 17, 2010 | Oct. 6, 2015 | Benoit | Electric radiator using |
| | | | | calculating processors as a |
| | | | | heat source |
| U.S. Pat. No. 3,887,788 | Jun. 26, 1973 | Jun. 3, 1975 | Robert; Roy | Condensation free mirror |
| U520150261269 | Mar. 12, 2015 | Sep. 17, 2015 | Bruscoe | Case for computer |
| U.S. Pat. No. 6,336,080 | Feb. 22, 2000 | Jan. 1, 2002 | Atkinson | Thermal management for |
| | | | | computers |
| U.S. Pat. No. 7,370,242 | May 23, 2005 | May 6, 2008 | Chen; Xiong; | Thermal monitoring and |
| | | | Ratty | response apparatus |
| U.S. Pat. No. 8,548,640 | Dec. 21, 2010 | Oct. 1, 2010 | Belady; James; Liu | Home heating server |

### SUMMARY

The instant application discloses a heat source which provides heat and may also provide processor power for a distributed trust protocol. The instant application may use electricity otherwise consumed by heating appliances to make heat by operating processors providing processing power available to support a distributed trust protocol. The instant application discloses device features and business models that afford an electric heat source which may also help to secure data for distributed trust protocols and/or generate revenue.

The business method of the instant application may subsidize, in part or whole, the cost of supporting infrastructure, manufacturing, distributing, buying, or using of certain electrical devices that may produce heat. The invention may subsidize some or all costs associated with heating because many distributed trust protocols reward suppliers of processor power with digital tokens or coins that may be traded for government issued currency.

### Definitions

Distributed trust protocol—A protocol that weaves a system of technologies together to create a secure place to store, access, and share data. It allows unfamiliar parties on the internet to “trust” information or data. For the purposes of the instant application, distributed trust protocol may include decentralized applications.
Blockchain protocol—A type of distributed trust protocol that secures data utilizing a “blockchain”, or a recorded history of connected blocks of data, to create a permanent, immutable, and unalterable record. Typically new data is presented to the network for validation, if/once accepted, it is recorded to the history of activity on all full nodes in the greater network. There are public and private variations:
Public Blockchain—Typically the protocol is open source and freely auditable. The rules of the protocol often use a consensus driven, democratic, majority rules method. This is achieved by crypto currency miners and node operators who select the version of the protocol they believe to be accurate and provide processing power. The protocol recognizes the consensus version and implements the rules accordingly.
Private Blockchain—Often the code for the protocol is owned and private. Decision over protocol rules is controlled by a single or consortium of actors.
Greater network—The collection of nodes supporting a distributed trust protocol.
Full node—A networked computer that is running firmware/software for a distributed trust protocol and communicating and crosschecking data with peers to actively maintain a full history of activity within the protocol.
Light node—A networked computer or device that is running a “light” variant of a distributed trust protocol that allows access for reading, entering or validating data, but maintains limited or no history. By not recording the history a light node requires less memory and far less data transmission through an internet service provider.
Solo miner—A device that operates as a full node, gets data directly from the protocol, and uses processing power to try to be first to validate activity.
Pool miner—A device that typically operates as a light node and accesses an intermediary to get its data. The intermediary has a full node, gets data from the protocol, and breaks it down into work packages. This allows distributed processors to operate independently to get work, and collaboratively to try to be the first to validate activity.

### BRIEF DESCRIPTION OF DRAWINGS

FIG. 1 shows a possible representation of an Electric Radiator in a case.

FIG. 2 shows a possible representation of an Electric Radiator with case removed.

FIG. 3 shows a business method where the Electric Radiator may be employed.

### DETAILED DESCRIPTION

In the Summary above and in this Detailed Description, and the claims below, and in the accompanying drawings, reference is made to particular features of the instant application. It is to be understood that the disclosure of Electric Radiator Using Calculating Processors as a Heat Source in this specification does not include all possible combinations of such particular features. For example, where a particular feature is disclosed in the context of a particular aspect or embodiment of the instant application, or a particular claim, that feature can also be used—to the extent possible—in combination with and/or in the context of other particular aspects and embodiments of the instant application, and in the instant application generally.

The following description of various embodiments of the invention is presented for the purposes of illustration and description. It is not intended to be exhaustive or to limit the invention to the precise form disclosed. It is intended that the scope of the invention be limited not by this detailed description, but rather by the claims appended hereto. The following specification, examples, and data provide a complete description of the manufacture and use of the invention. Since many embodiments of the invention can be made without departing from the spirit and scope of the invention, the invention resides in the claims hereinafter appended.

According to the instant application, an electric radiator may comprise an onboard controller managing at least one processing circuit (possibly an application specific integrated circuit (or “ASIC”)), where a computing processor is provided, the latter being connected to a dissipating block to remove heat in the heating body, one or more control interfaces, an electric power supply, and a communication interface.

The processors providing heat in the electric radiator may be participating in a distributed trust protocol. The revenue generated for participating in the distributed trust protocol or the cost reduction in data security may offset utility (i.e. electrical), manufacturing, or other costs associated with a device. The use of electricity by the radiator may also reduce the environmental impact of securing a distributed trust protocol.

An entity may employ the electric radiator at full, no, or reduced cost to users in order to secure a private or distributed trust protocol or to gain control of hash power.

Due to the network interface, the control interface can be accessed by mobile applications, web applications, or other similar standard interfaces allowing the user to switch on or off, adjust temperature, set a schedule or adjust other settings remotely. It also makes possible for the invention to join the IOT (internet of things).

In the instant application, a user may obtain a device and may support a distributed trust protocol of their choice as the user may have autonomy over their device. The device may be purchased, leased, or received for free by a user in order to perform a heat function. Users, depending on the embodiment of the device, may control the devices' settings, network connectivity, processor power objective, power usage, heating output, maintenance, and replacement, selecting which networks to connect to, and whether to use the radiator for heat at all.

In some embodiments, the electric radiator may be used within an apartment, home, business, or any commercial, industrial or government facility and may be used in the form of a common portable space heater or as an integrated fixture in a building such as a wall heater or a central furnace.

The instant application discloses a business method of a business which may distribute electric radiators which may provide processor power for a distributed trust protocol, and thus may produce revenue.

Also disclosed is a method that an entity may pay, in part or whole (in digital or government issued money) for costs associated with an electric radiator that may participate in a distributed trust protocol. Alternatively, an entity may distribute electric radiators at full, low, or no cost to obtain processor or hash power. An entity may also operate a network of electric radiators so as to control and direct processor (hash) power for profit.

The instant application also discloses a business method of repurposing computing equipment for use in electric radiators which may produce revenue. This method may have environmental appeal for reusing otherwise unused electronics.

The instant application also discloses a business method of selling electric radiators with marketable advantages over existing radiators, paid for by revenue generated by participating in certain distributed trust protocols. These advantages may include lifetime warranty or network enabled user interfaces.

The heating body may be of different types depending on the number and design of processors relative to the embodiment. It may use passive air cooling for an embodiment such as a curling iron, or cooling through a heat transfer fluid such as air or mineral oil. Some embodiments include: fan blown air cooling for a space heater or clothes dryer heating element, submerged cooling in a fluid such as mineral oil for a home furnace. Submerged cooling may involve putting the heating processors in a tank or container filled with a liquid cooling fluid that is flowing, by an electrical pump, to a radiator where forced air may be the heat transfer fluid. This heat transfer fluid may come from an external circuit.

The processors may be distributed on a number of printed circuit board(s), referred to henceforth as “processor circuit boards,” which may respond to an onboard controller. In some embodiments, the controller board may be integrated with a processor circuit board or integrated into the processor itself. The onboard controller is configured so as to seek out work on a distributed trust protocol and transmit completed work in an effort to gain payment, this availability depending on the user's demands for heat.

The instant application may provide a heat exchange interface by means of the pumped liquid coolant when submerged, or through a heat dissipating material for the different electrical components, in particular the processors, but also the other components discharging heat: chipset, random access memories, mass memories, and power supply. Heat dissipation material may be used in tandem with submerged cooling.

An electric radiator may provide connection interfaces other than the mere network interface. These may be video, audio, series, parallel interfaces allowing a use of the radiator being comparable to that of a microcomputer, a multimedia box or a video game console by connecting external peripherals (screen, keyboard, remote controller, joysticks, audio speakers). This allows an electric radiator to be included into devices not used for heating, such as a personal computer, and allow the distributor to generate revenue in exchange for use of the electric radiator.

In another business method, an electric radiator may participate in a distributed trust protocol and may be configured with smart contract(s).

In another embodiment, calculating processors supporting a distributed trust protocol may generate heat for clothes dryers, dishwashers, ovens, toasters, baby bottle warmers, curling irons, hair dryers, hair straighteners, blown air hand driers, clothes irons, humidifiers/dehumidifiers, heated blankets, coffee makers, heated floors or surfaces, heated towel racks, engine block heaters, electric car comfort air heaters, heated seats, heated steering wheels, shoe/boot/sock dryers, 3D printers, heat rocks for reptiles, water distillers, and water heaters for potable water (building or mobile), fish tanks, swimming pools or hot tubs or other devices that may utilize an electric processing heating element.

In some embodiments, the control interface may be machine-machine and/or human-machine in nature. An interface may be a simple manual on/off switch or a machine function such as a relay. In many embodiments a thermostat can provide an on/off function or a temperature probe will provide the onboard firmware or software temperature data. Onboard software or firmware can throttle the processing power or activate and deactivate processors to maintain the desired temperature.

In some embodiments, a control interface may allow consumer and technical level access to the firmware or software. Access in some embodiments may be through a wireless network. For example, in the home heating embodiment, consumer controls may include temperature, schedule, and wireless network/password inputs while protocol selection and administrative access to firmware or software may be through a technical interface. It also may be possible to allow the consumer to control which protocol their device supports, to allow the consumer to direct their processing power to the network of their choice directly.

Moreover, the processes involved in participating within distributed trust protocols such as blockchain protocols are not anticipated by the prior art. The prior art uses remote processors and/or servers that are accessed externally and given direction to perform computing functions in response to a user in a master/slave relationship.

In the current invention, the device differentiates itself by, when signaled for heat, the onboard software/firmware allows the device to function as an autonomous agent that accesses data from the greater network and enters into a race to validate activity within the protocol. In the current invention, the device itself acts as the user and independently accesses the external greater network to find information.

U.S. Pat. No. 9,151,515 describes a similar system that produces heat from processors. In that patent, the system described is tailored to that of a distributed processor network where one entity likely owns all of the component processors which provide the computing power, and centrally and externally controls and manages the function of the processors. That patent's system anticipates that a single entity, such as a university, would own and manage the infrastructure and processing power objective. Distinctly, there is a master/slave relationship between an external user and the distributed processors.

The current invention is notably different, and operates in a different way, which is not anticipated by U.S. Pat. No. 9,151,515. The current invention uses processors embedded within networked devices and equipment that offer an electric heating function, such as a space heater or coffee maker. As heat is demanded of the current invention, the processors respond to onboard software/firmware and begin providing heat by working to support certain distributed trust protocols; functioning independently and autonomously.

U.S. Pat. Nos. 8,548,640 and 9,151,515 both use terminology and technology similar to the instant application but are different in that they use distributed servers and processors that are accessed and controlled externally, making each distributed component respond to the external controller.

The instant application may use an onboard controller with onboard software/firmware that locally directs the functioning of the device. The device in the instant application, while requiring communicative access to the distributed trust protocol, is not required to be accessed externally to perform its function. Instead, the onboard features noted above control the functioning of the device and make each device an autonomous node supporting certain distributed trust protocols.

The instant application, while having features noted in U.S. Pat. Nos. 8,548,640 and 9,151,515, is focused on the heat created by supporting distributed trust protocols, such as blockchain protocols, and the network security and/or revenue available for supporting various protocols.

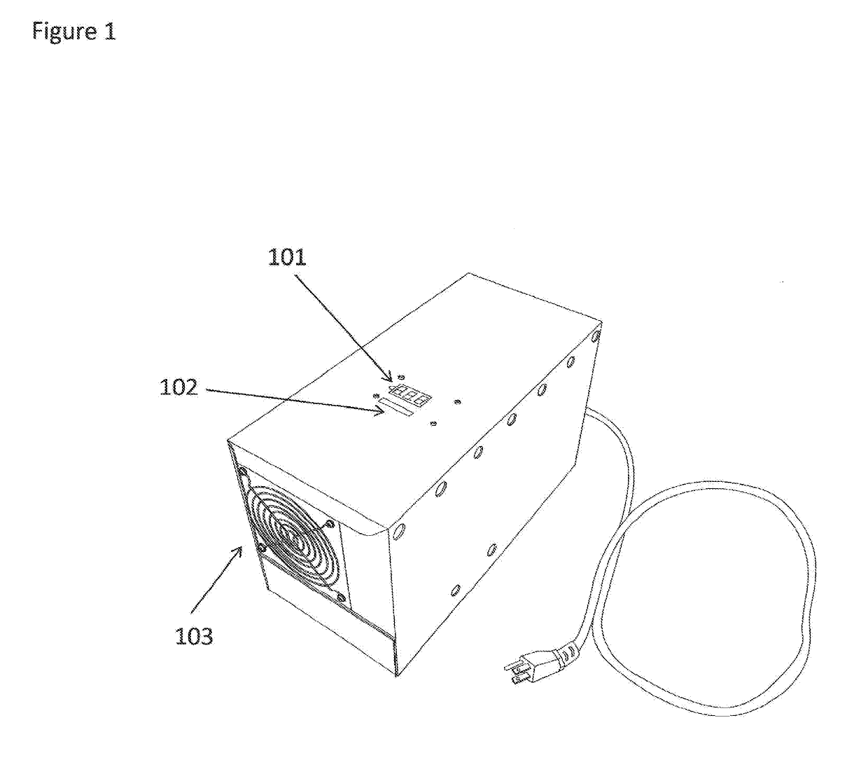

The following is a detailed description of FIG. 1:

FIG. 1 is an outside view of an Electric Radiator Using Calculating Processors as a Heat Source.
A display is located on the case, 101, which may display temperature.
A control interface is located on the case, 102, which may control the temperature setting and an active or inactive state of the device.
An exhaust fan, 103, blows heated air out of the device.

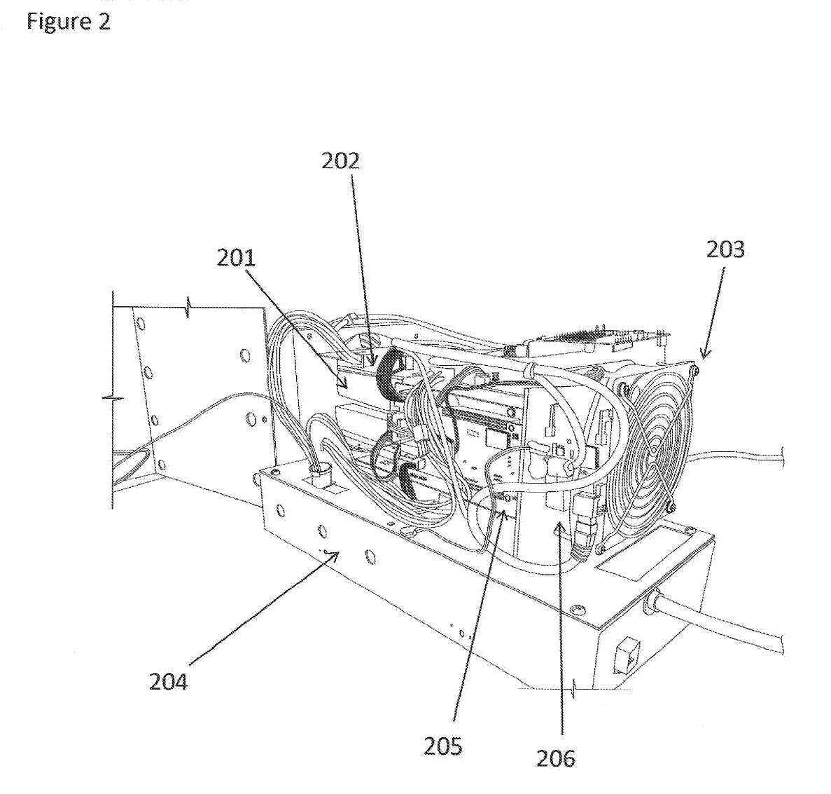

The following is a detailed description of FIG. 2:

FIG. 2 is an internal view of an Electric Radiator Using Calculating Processors as a Heat Source with the case removed.
Heat sinks, 201, may aid in transferring the heat from the processor circuit boards, 202, out of the device.
At the opposite end of the exhaust fan, shown in FIG. 1 as 103, an intake fan, 203, may aid in moving unheated air into the device.
A wi-fi interface, 206, may allow the device to connect to a network.
A controller board, 205, controls the processors.
A heat supply, 204, powers the device.

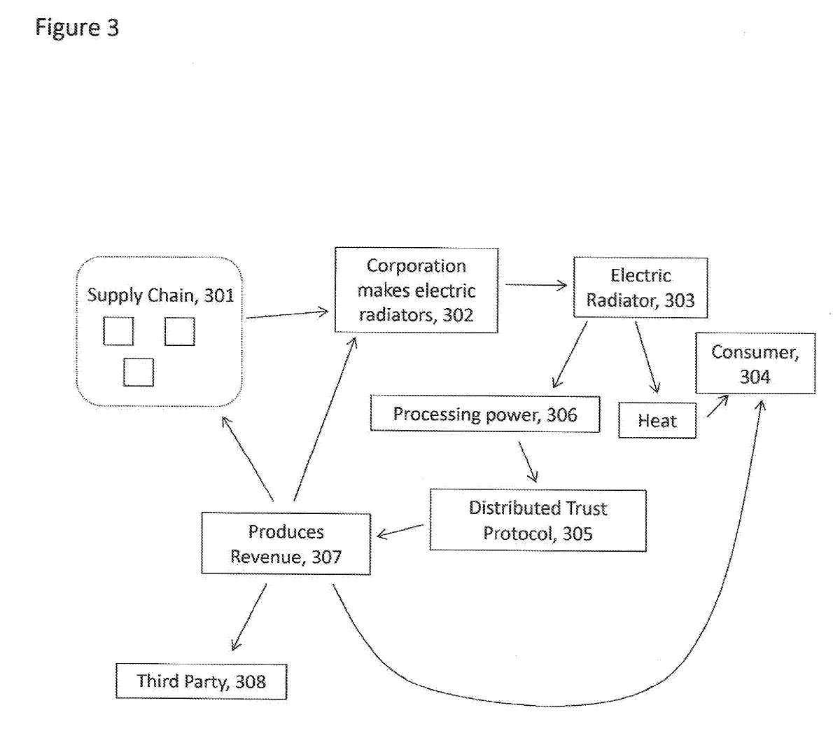

The following is a detailed description of FIG. 3:

FIG. 3 is a business method which may employ an Electric Radiator Using Calculating Processors as a Heat Source.
A supply chain, 301 delivers materials to a corporation, 302. The materials may be brand new, recycled, repurposed, or reconditioned electronics components which may be capable of participating in a distributed trust network, or may have capabilities combined with other electronics to do so. The delivered materials may be exchanged for free, partial, or full payment of their value.
The corporation, 302, may distribute electric radiators, 303, or components to consumers, 304. The distribution may be accomplished by sales, leases, work contracts, or through a retailer.
The electric radiator may produce heat. The consumer may enjoy the heat for any purpose from building heat to an electric coffee pot heating element. Any appliance which creates heat may utilize this method.
The electric radiator produces processing power, 306, as a byproduct of the heat created. The processing power may be directed to a distributed trust protocol, 305, directly or through an intermediary.
The distributed trust protocol may earn revenue for one or more of the entities involved in the method, 305.
The revenue may return to the supply chain, 301.
The revenue may return to the corporation for revenue or redistribution, 302.
The revenue may return to the consumer, 304.
The revenue may return to a third party, 308.

1. An electric radiator comprising:
A) An onboard controller that can respond to a signal that heat is needed and independently control processors to support certain distributed trust protocols, such as certain blockchain protocols, for network security and/or profit.
B) A heat source formed by at least one processing circuit whereon at least one computing processor is provided, matched to the needs of the embodiment.
C) A heating body meeting the needs of the embodiment.
D) An electric power supply capable of
E) A communication interface enabling the device to contact an external computer network

2. A business method wherein the device in claim 1 may be employed to provide no- or reduced-cost heat.

3. A business method wherein the device in claim 1 may be employed to provide full, no- or reduced-cost devices, equipment, and other associated costs.

4. A business method wherein the device in claim 1 may utilize recycled, reused, or repurposed electronic components.

5. A business method wherein the device in claim 1 may be employed to provide an individual, group, or corporation with control over processing power.
